(19) United States
(12) Patent Application Publication
(10) Pub. No.: US 2015/0103096 A1
(43) Pub. Date: Apr. 16, 2015

(54) DISPLAY DEVICE, HEAD MOUNT DISPLAY, CALIBRATION METHOD, CALIBRATION PROGRAM AND RECORDING MEDIUM

(71) Applicant: Akira Gotoda, Kanagawa (JP)

(72) Inventor: Akira Gotoda, Kanagawa (JP)

(73) Assignee: PIONEER CORPORATION, Kanagawa (JP)

(21) Appl. No.: 14/404,794

(22) PCT Filed: May 30, 2012
(86) PCT No.: PCT/JP2012/063986

§ 371 Date: Dec. 1, 2014

(51) Int. Cl. G02B 27/01; G06T 11/60

(52) U.S. Cl. CPC G02B 27/0179; G06T 11/60; G02B 27/017; G02B 27/0172; G02B 2027/0178; G02B 2027/0196; G02B 2027/0138
USPC 345/633

(57) ABSTRACT

An optically transmissive display device is configured displays additional information to a real environment visually recognized by a user. The display device includes: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image. The specific position in the real environment in the calibration unit is specified by detecting the position of the natural feature point determined by the determining unit.

### TECHNICAL FIELD

The present invention relates to a technical field of adding and presenting information to a real environment.

### BACKGROUND TECHNIQUE

Conventionally, there is proposed a technique related to AR (Augmented Reality) which adds and presents additional information such as CG (Computer Graphics) and characters to a real environment by using an optically transmissive display device such as a head mount display. Further, there is proposed a technique of calibration to correct deviation between a position of a real image viewed from a viewpoint of a user and a display position of the information in AR using such an optically transmissive display device (hereinafter conveniently referred to as “optically transmissive type AR).

For example, Non-Patent Reference 1 discloses a technique in which a user adjusts a position of a marker on the real environment and the display position on the display to perform the calibration based on the information at that time. Also, Patent Reference 1 discloses, not calibrating for each user, but notifying the deviation between the position of an eyeball at the time of the previous calibration and the present position of the eyeball to remove the deviation of the synthesizing position without re-calibration.

Further, Patent Reference 2 discloses a technique for a device having a head mount display of an optically transmissive type, a camera for capturing the outside world and a visual line detecting means, wherein a specific range in the camera for capturing the outside world is selected based on the movement of the user's visual line, and the selected range is captured by the camera as the image information to be processed. In this technique, while reading English aloud for example, the area designated by the visual line is image-processed, read and translated to display data. Further, Patent Reference 3 discloses accurately detecting the position of the pupil to correct the display position based on the position of the pupil, in a medical-use display device.

### PRIOR ART REFERENCES

### Patent References

Patent Reference 1: Japanese Patent Application Laid-open under No. 2006-133688
Patent Reference 2: Japanese Patent Application Laid-open under No. 2000-152125
Patent Reference 3: Japanese Patent Application Laid-open under No. 2008-18015

### Non-Patent Reference

Non-Patent Reference 1: Kouichi Kato, Mark Billinghurst, Kouichi Asano, Keihachiro Tachibana, “Augmented Reality System based on Marker Tracking and its Calibration”, Japanese Virtual Reality Society Journal, Vol. 4, No. 4, pp. 607-616, 1999

### SUMMARY OF INVENTION

### Problem to be Solved by the Invention

By the technique disclosed in Non-Patent Reference 1, using the marker is necessary, and the user needs to possess the marker for the calibration even in an outdoor use.

On the other hand, the technique of Patent Reference 1 requires a configuration of freely changing the eye position, and is not applicable to the case where setting or change of the position of the camera and/or the display device is desired. In the technique of Patent Reference 2, since the calibration is not performed, the display position may possibly shift from the desired position. Further, the technique of Patent Reference 3 is not applicable to the case where the setting or change of the position of the camera and/or the display device is desired.

By the way, Non-Patent Reference 1 and Patent References 1 to 3 do not disclose performing calibration based on a natural feature point existing in real environment.

The above is one example of a problem to be solved by the present invention. It is an object of the present invention to provide a display device, a head mount display, a calibration method, a calibration program and a recording medium capable of appropriately performing calibration based on a natural feature point.

### Means for Solving the Problem

The invention described in claim is a display device of optically transmissive type which displays additional information to a real environment visually recognized by a user, comprising: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

The invention described in claim is a head mount display of optically transmissive type which displays additional information to a real environment visually recognized by a user, comprising: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

The invention described in claim is a calibration method executed by a display device of optically transmissive type which displays additional information to a real environment visually recognized by a user, comprising: a position detecting process which detects a specific position in the real environment; a calibration process which obtains a correspondence between the specific position in the real environment and a specific position of the display device to compute calibration data for transforming from a first coordinate system prescribed by the position detecting process at the specific position in the real environment to a second coordinate system of the display device; and a determining process which determines a natural feature point suitable for computing the calibration data in the natural feature points existing in the real environment, based on a taken image taken by imaging the real environment by an imaging device, wherein the position detecting process specifies the specific position in the real environment in the calibration process by detecting the position of the natural feature point determined by the determining process.

The invention described in claim is a calibration program executed by a display device of optically transmissive type which includes a computer and which displays additional information to a real environment visually recognized by a user, making the computer function as: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

In the invention, the recording medium stores the calibration program.

### BRIEF DESCRIPTION OF THE DRAWINGS

FIG. 1 is an external view showing a schematic configuration of a HMD.

FIG. 2 is a diagram schematically illustrating an internal configuration of the HMD.

FIGS. 3A to 3C are diagrams for explaining the reason why calibration is performed.

FIG. 4 is a block diagram showing a configuration of a control unit according to the embodiment.

FIG. 5 is a flowchart showing entire processing of the HMD.

FIG. 6 is a flowchart showing calibration processing according to the embodiment.

### DETAILED DESCRIPTION OF THE PREFERRED EMBODIMENT

According to one aspect of the present invention, there is provided a display device of optically transmissive type which displays additional information to a real environment visually recognized by a user, comprising: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

The display device is configured to realize an optically transmissive type AR, and displays additional information to a real environment visually recognized by a user. The position detecting unit detects a specific position in the real environment. The calibration unit obtains a correspondence between the specific position in the real environment and a specific position of the display device to compute calibration data for transforming from a first coordinate system of the position detecting unit at the specific position in the real environment to a second coordinate system of the display device. The determining unit determines a natural feature point suitable for computing the calibration data in the natural feature points existing in the real environment, based on a taken image taken by imaging the real environment by an imaging device. Then, the display device specifies the specific position in the real environment in the calibration unit by detecting the position of the natural feature point determined by the determining unit. By the above display device, the calibration of the display device can be appropriately performed by using the natural feature point existing in the real environment. Specifically, the calibration can be appropriately performed in an environment in which an artificial feature point such as a marker does not exist.

One mode of the above display device further comprises a presenting unit which presents the natural feature point determined by the determining unit to the user. Preferably, the presenting unit displays an image in accordance with the taken image of the real environment including the natural feature point. Thus, the object natural feature point may be appropriately grasped by the user.

In another mode of the above display device, the determining unit determines an optimum image-taking direction including the natural feature point for an image-taking direction of the imaging device based on the taken image, the position detecting unit detects the position of the natural feature point included in the optimum image-taking direction, and the first coordinate system is a coordinate system of the imaging device.

Preferably in the above display device, the determining unit determines, as the optimum image-taking direction, the image-taking direction in which plural natural feature points which are not similar and whose position does not move disperse. By using this image-taking direction, it is possible to appropriately detect the position of the natural feature point and accurately compute the calibration data.

Another mode of the above display device further comprises a visual line direction detecting unit which detects a visual line direction of the user when the user directs the visual line to the natural feature point, wherein the calibration unit computes the calibration data based on the position detected by the position detecting unit and the visual line direction detected by the visual line detecting unit.

According to the above display device, since the calibration is performed based on the visual line direction, it is only necessary for the user to perform the behavior of directing the visual line to the natural feature point at the time of calibration. At the time of calibration, this behavior puts less burden on the user than the behavior of moving the display device and/or the marker to make the displayed cross and the marker coincide with each other as described in Non-Patent Reference 1, i.e., requires less burden and time. In addition, if the display device is for both eyes, by providing the visual line direction detecting unit for each of left and right eyes, the calibration can be performed for both eyes at the same time. Thus, according to the above display device, the burden on the user at the time of the calibration may be effectively reduced.

In another mode of the above display device, the visual line direction detecting unit detects the visual line direction when the user operates an input unit for inputting that the user is gazing. In this mode, the user notifies his or her gazing by operating the input unit such as a button. Thus, it is possible to detect the visual line direction at the time when the user is gazing the natural feature point.

In another mode of the above display device, the visual line direction detecting unit detects the visual line direction when the user performs the gazing operation for a predetermined time period. Thus, the disturbance of the visual line direction and/or the movement of the head may be suppressed in comparison with the case of notifying the gazing by the operation of the button. Therefore, the error factor at the time of the calibration can be reduced, and the accuracy of the calibration can be improved.

In another mode of the above display device, the visual line direction detecting unit detects the visual line direction when the user blinks. Thus, the disturbance of the visual line direction and/or the movement of the head may be suppressed in comparison with the case of notifying the gazing by the operation of the button. Therefore, the error factor at the time of the calibration can be reduced, and the accuracy of the calibration can be improved.

In a preferred example, the visual line direction detecting unit obtains the coordinates in the second coordinate system corresponding to an intersection point of the visual line direction and a display surface by the display device, and the calibration unit computes the calibration data based on the coordinates obtained by the visual line direction detecting unit and the position detected by the position detecting unit.

According to another aspect of the present invention, there is provided a head mount display of optically transmissive type which displays additional information to a real environment visually recognized by a user, comprising: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

According to still another aspect of the present invention, there is provided a calibration method executed by a display device of optically transmissive type which displays additional information to a real environment visually recognized by a user, comprising: a position detecting process which detects a specific position in the real environment; a calibration process which obtains a correspondence between the specific position in the real environment and a specific position of the display device to compute calibration data for transforming from a first coordinate system prescribed by the position detecting process at the specific position in the real environment to a second coordinate system of the display device; and a determining process which determines a natural feature point suitable for computing the calibration data in the natural feature points existing in the real environment, based on a taken image taken by imaging the real environment by an imaging device, wherein the position detecting process specifies the specific position in the real environment in the calibration process by detecting the position of the natural feature point determined by the determining process.

According to still another aspect of the present invention, there is provided a calibration program executed by a display device of optically transmissive type which includes a computer and which displays additional information to a real environment visually recognized by a user, making the computer function as: a position detecting unit which detects a specific position in the real environment; a calibration unit which obtains a correspondence between the specific position in the real environment and a specific position of the display device to compute calibration data for transforming from a first coordinate system of the position detecting unit at the specific position in the real environment to a second coordinate system of the display device; and a determining unit which determines a natural feature point suitable for computing the calibration data in the natural feature points existing in the real environment, based on a taken image taken by imaging the real environment by an imaging device, wherein the position detecting unit specifies the specific position in the real environment in the calibration unit by detecting the position of the natural feature point determined by the determining unit.

The above calibration program may be preferably handled in a manner stored in a recording medium.

### EMBODIMENTS

A Preferred embodiment of the present invention will be described below with reference to the attached drawings.

[Device Configuration]

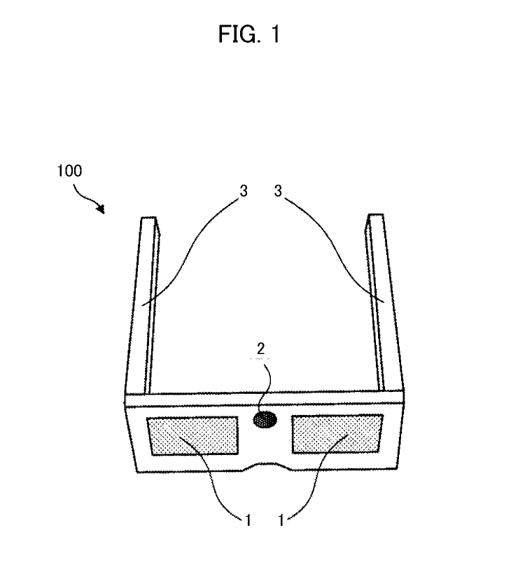

FIG. 1 is an external view of a schematic configuration of a head mount display (hereinafter referred to as “HMD”) according to an embodiment of the present invention. As shown in FIG. 1, the HMD 100 mainly includes transmissive type display units 1, an imaging unit 2 and mounting parts 3. The HMD 100 is configured in a shape of eyeglasses, and a user mounts the HMD 100 on the head in use. The HMD 100 displays CG, serving as an example of “additional information” in the present invention, on the transmissive type display units 1 in correspondence with the position of the marker provided in real environment, thereby to realize AR (Augmented Reality). The HMD 100 is an example of “the display device” in the present invention.

The imaging unit 2 includes a camera, and takes an image of the real environment ahead of the user in a situation where the user wears the HMD 100. The imaging unit 2 is provided between the two transmissive type display units 1 aligned on the left and right. In this embodiment, a natural feature point and a position of a marker are detected based on the image taken by the imaging unit 2.

The mounting parts 3 are members to be mounted on the head of the user (members of the shape like a frame of eyeglasses), and are formed to be able to sandwich the head of the user from the left and right sides.

The transmissive type display units 1 are formed optically transmissive, and one transmissive type display unit 1 is provided for each of the left and right eyes of the user. The user who views the real environment through the transmissive type display units 1 and views CG displayed on the transmissive type display units 1 feels as if the CG not existing in the real environment is existing in the real environment. Namely, AR (Augmented Reality) can be realized.

In order to detect three-dimensional positions such as the natural feature points by using the image taken by the imaging unit 2 (the detail will be described later), the imaging unit 2 is preferably configured as a stereo camera. However, it is not limited to use a stereo camera. In another example, a monocular camera may be used. In that case, the three-dimensional positions may be detected by using a marker having known size and feature, a picture marker, or a three-dimensional object, or by using the difference of viewpoints caused by the movement the camera. In still another example, the three-dimensional positions can be detected by using a TOF (Time-Of-Flight) camera and a visible light camera in combination as the imaging unit 2. In still another example, the three-dimensional positions can be detected by using triangulation utilizing a camera and a pattern projection by a laser or a projector.

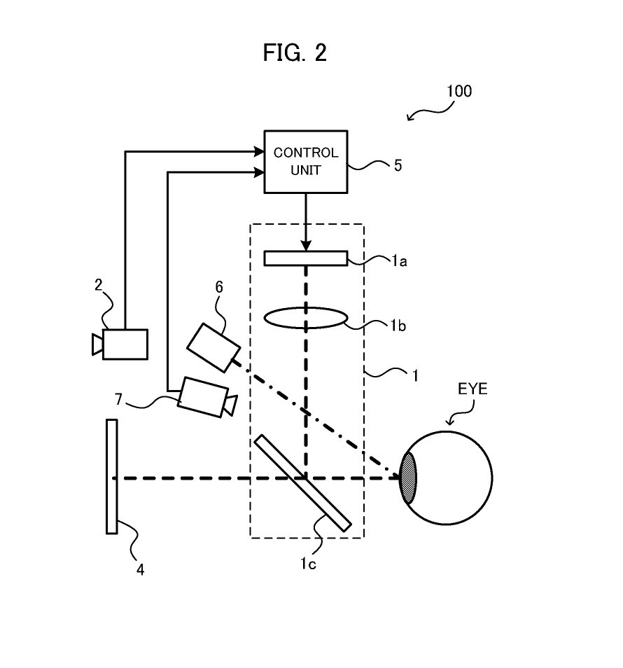

FIG. 2 is a diagram schematically illustrating an internal configuration of the HMD 100. As shown in FIG. 2, the HMD 100 includes a control unit 5, a near infrared light source 6 and a visual line direction detecting unit 7, in addition to the transmissive type display units 1 and the imaging unit 2 described above. Also, the transmissive type display unit 1 includes a display unit 1a, a lens 1b and a half mirror 1c (see. the area enclosed by the broken line).

The display unit 1a is configured by a LCD (Liquid Crystal Display), a DLP (Digital Light Processing) or an organic EL, and emits a light corresponding to an image to be displayed. The display unit 1a may be a configuration of scanning a light from a light source by a mirror. The light emitted by the display unit 1a is magnified by the lens 1b and reflected by the half mirror 1c, to be incident on the eye of the user. By this, the user visually recognizes a virtual image formed on a surface indicated by the reference numeral 4 in FIG. 2 (hereinafter referred to as “display surface 4”) via the half mirror 1c.

The near infrared light source 6 irradiates the near infrared light on the eyeball. The visual line direction detecting unit 7 detects the visual line direction of the user by detecting the reflected light of the near infrared light reflected by the surface of the cornea (Purkinje image) and the position of the pupil. For example, a known corneal reflex method (One example: Yusuke Sakashita, Hironobu Fujiyoshi, Yutaka Hirata, “3-Dimensional Eyeball Motion Measurement by Image Processing”, Experimental Dynamics, Vol. 6, No. 3, pp. 236-243, September 2006″) may be applied to the detection of the visual line direction. In this method, by performing the work of gazing the display of HMD 100 plural times to calibrate the detection of the visual line direction, it is possible to accurately detect the position on the display of the HMD 100 where the user is watching. The visual line direction detecting unit 7 supplies information of the visual line direction thus detected to the control unit 5. The visual line direction detecting unit 7 is an example of the “visual line direction detecting unit” in the present invention.

The control unit 5 includes a CPU, a RAM and a ROM which are not shown, and performs total control of the HMD 100. Specifically, the control unit 5 performs the processing of calibrating the display position of the CG and the rendering of the CG to be displayed, based on the image taken by the imaging unit 2 and the visual line direction detected by the visual line direction detecting unit 7. The control performed by the control unit 5 will be described later in more detail.

The method of detecting the visual line direction is not limited to the above-described method. In another example, the visual line direction may be detected by taking the image of the eyeball reflected by an infrared half mirror. In still another example, the visual line direction may be detected by detecting the pupil or the eyeball or the face by a monocular camera. In still another example, the visual line direction may be detected by using a stereo camera. In addition, the detection of the visual line direction is not limited to the method of contactless type, and a contact type method of detecting the visual line direction may be used.

[Calibration Method]

Next, the calibration method according to the embodiment will be specifically described.

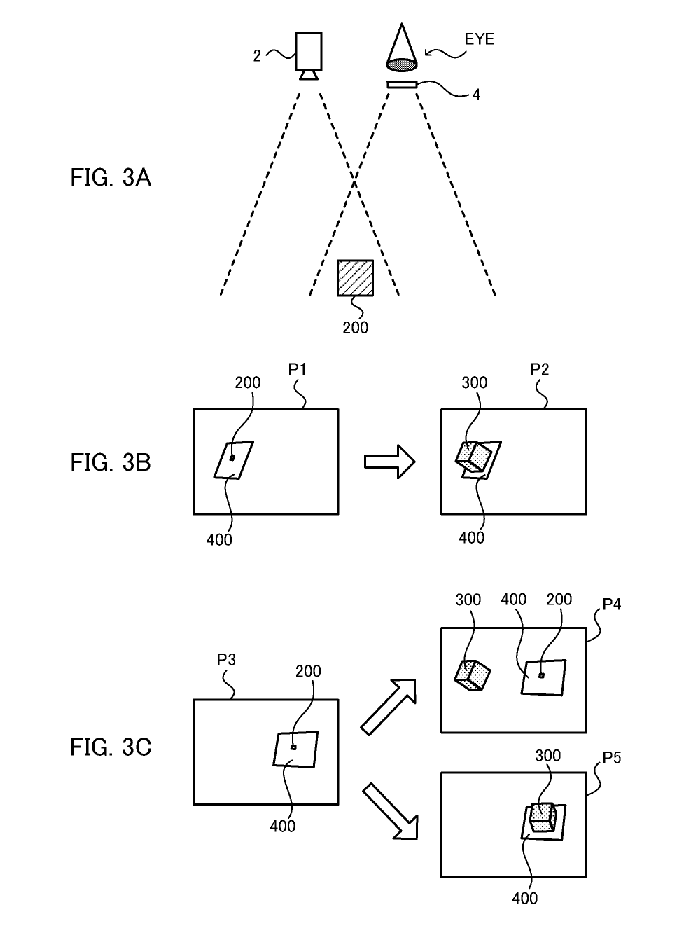

FIG. 3 is a diagram for explaining the reason why the calibration is performed. As shown in FIG. 3A, since the position of the eye of the user and the position of the imaging unit 2 are different from each other in the HMD 100, the image (taken image) taken by the imaging unit 2 and the image captured by the eye of the user are different from each other. For example, it is assumed that the eye of the user, the imaging unit 2 and the marker 200 provided in the real environment are in a positional relation shown in FIG. 3A. In this case, the marker 200 is positioned on the left side of the image P1 (see. FIG. 3B) taken by the imaging unit 2, but the marker 200 is positioned on the right side of the image P3 captured by the eye of the user (see. FIG. 3C). It is noted that the marker 200 is provided on an object 400 in the real environment. The marker 200 is one of the objects to which the additional information such as CG is presented.

Here, if the position of the marker 200 is detected based on the image P1 taken by the imaging unit 2 and the CG 300 is synthesized on the detected position in the image P1, the image P2 is created in which the positions of the CG 300 and the marker 200 are coincident. However, in an optically transmissive type display device such as the HMD 100, it is necessary to perform the calibration in accordance with the difference between the position of the eye of the user and the position of the imaging unit 2. If the calibration is not performed, as shown by the image P4 in FIG. 3C, the position and the posture (direction) of the marker 200 and the CG 300 may be shifted from each other from the viewpoint of the user.

Therefore, in this embodiment, the control unit 5 performs the correction to make the position and the posture (direction) of the CG 300 and the marker 200 coincide with each other, as shown by the image P5 in FIG. 3C. Specifically, the control unit 5 performs the correction by transforming the image on the basis of the imaging unit 2 to the image of the HMD 100 on the basis of the eye. Namely, the control unit 5 performs the transformation from the coordinate system in the imaging unit 2 (hereinafter referred to as “the imaging coordinate system”) to the coordinate system by the display of the HMD 100 (hereinafter referred to as “the display coordinate system”). The imaging coordinate system is an example of the “first coordinate system” in the present invention, and the display coordinate system is an example of the “second coordinate system” in the present invention.

In this embodiment, as the calibration, the control unit 5 executes the processing (hereinafter referred to as “calibration processing”) of computing calibration data which is a matrix for the transformation from the imaging coordinate system to the display coordinate system. The calibration data is determined by the relation of the position and the posture of the display surface 4, the imaging unit 2 and the eye. In a case where the display surface 4, the imaging unit 2 and the eye move in the same direction or the same angle by the same amount, the same calibration data may be used without problem. Therefore, in the HMD 100, the calibration data is computed first (e.g., the calibration data is computed at the time of starting the use of the HMD 100 or at the time when the user requests the calibration), and thereafter the deviation described above is corrected by using the computed calibration data.

Specifically, in this embodiment, the control unit 5 computes the calibration data based on the visual line direction detected by the visual line direction detecting unit 7 and the image taken by the imaging unit 2. In this case, the control unit 5 uses the real environment including the natural feature point optimum for the calibration processing, and computes the calibration data for the transformation from the imaging coordinate system to the display coordinate system based on the position of the natural feature point in the imaging coordinate system detected from the taken image in such a real environment and the visual line direction detected by the visual line direction detecting unit 7 at the time when the user is gazing the natural feature point. More specifically, the control unit 5 computes the calibration data based on the position of the natural feature point in the imaging coordinate system and the coordinates in the display coordinate system (hereinafter referred to as the “visual line coordinate system”) at the intersection point of the visual line direction of the user and the display surface 4.

In this embodiment, the image of the surrounding real environment is taken by the imaging unit 2, and the calibration is performed by using the image-taking direction (hereinafter referred to as “an optimum image-taking direction” or “an optimum direction”) of the imaging unit 2 including the natural feature point optimum for the calibration processing. Here, the optimum image-taking direction will be described. In order to accurately compute the calibration data, it is desired that the list of the natural feature points to be gazed by the user disperses in a horizontal direction, a vertical direction and a depth direction with respect to the imaging unit 2. Therefore, the image-taking direction of the imaging unit 2 is good when it is the direction in which many natural feature points disperse. In addition, desirably it is the list of the natural feature points whose three-dimensional position can be easily detected. Detecting the three-dimensional position of the natural feature point needs accurate matching of the natural feature point within the image taken from plural viewpoints. For example, in a case of similar pattern like tiles on a wall, matching error between the images tends to increase. Also, for example, in a case of a moving object such as a leaf, the three-dimensional position cannot be accurately obtained because the three-dimensional position is different between the images taken at different image-taking timing. For the above reasons, as the optimum image-taking direction described above, it is desired to use the image-taking direction in which plural natural feature points which are not similar and whose position does not move disperse.

Further, in this embodiment, the control unit 5 uses a plurality of such natural feature points to obtain the positions of the natural feature points in the imaging coordinate system and the visual line direction coordinates in the image-taking coordinate system for those plural natural feature points, and computes the calibration data based on the plural positions of the natural feature points and the plural visual line direction coordinates thus obtained. Specifically, the control unit 5 designates one of the plural natural feature points, and when the user gazes the designated natural feature point, the control unit 5 designates another natural feature point. The control unit 5 repeats this process a predetermined times. Every time this process is executed, the control unit 5 obtains the position of the natural feature point in the image-taking coordinate system and the visual line direction coordinates, thereby to obtain the plural positions of the natural feature points and the plural visual line direction coordinates. In this case, the control unit 5 displays an image for designating the natural feature point to be gazed (hereinafter referred to as “a gazing object image”), and the user presses the button serving as a user interface (UI) for calibration when he or she gazes the natural feature point corresponding to the gazing object image, thereby to notify that he or she is gazing the natural feature point. For example, the control unit 5 displays, as the gazing object image, an image produced by scaling down and/or cutting out the taken image and emphasizing the natural feature point to be gazed by the user. In one example, it is an image in which the natural feature point to be gazed is displayed by a certain color or the natural feature point is enclosed by a circle.

As described above, the control unit 5 is an example of “a determining unit”, “a position detecting unit”, “a calibration unit” and “a designating unit” of the present invention.

[Configuration of Control Unit]

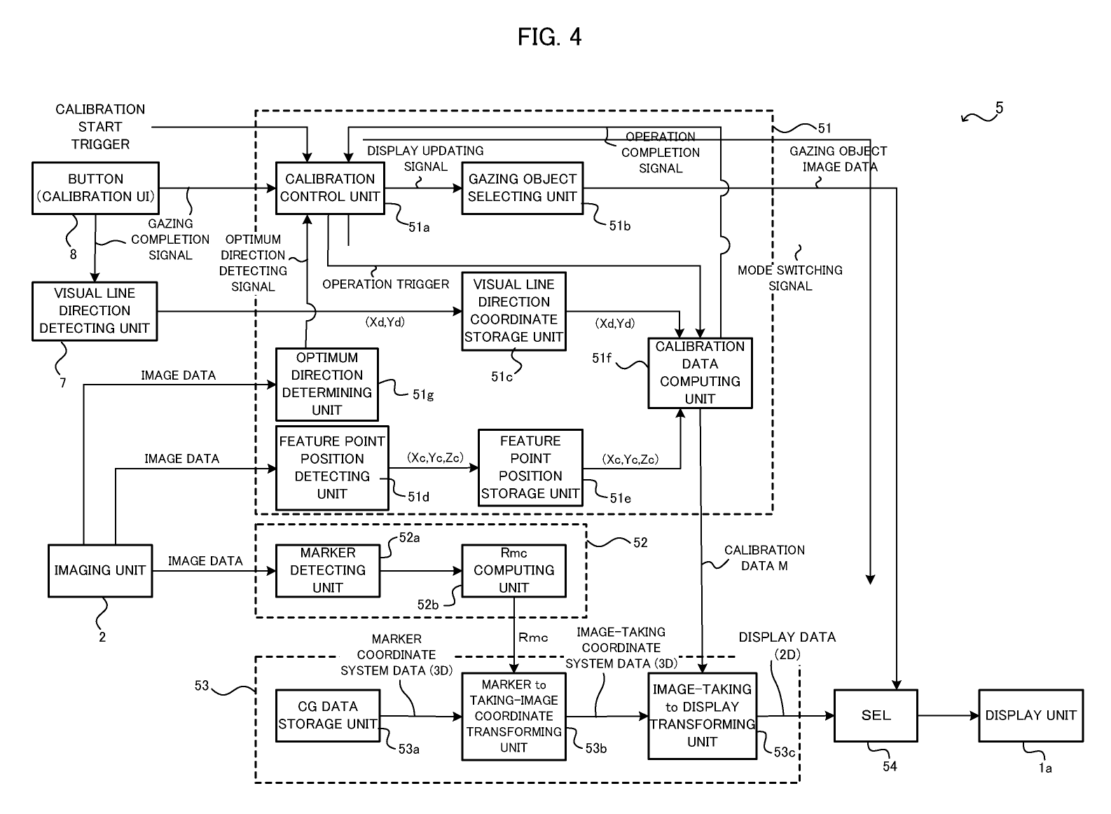

Next, the specific configuration of the control unit 5 according to this embodiment will be described with reference to FIG. 4.

FIG. 4 is a block diagram illustrating a configuration of the control unit 5 according to this embodiment. As shown in FIG. 4, the control unit 5 mainly includes a calibration unit 51, a transformation matrix computing unit 52, a rendering unit 53 and a selector (SEL) 54.

The button 8 is pressed when the user gazes the natural feature point, as described above. When pressed by the user, the button 8 outputs a gazing completion signal indicating that the user gazes the natural feature point to the visual line direction detecting unit 7 and the calibration unit 51. The button 8 is an example of “an input unit” of the present invention.

When the gazing completion signal is inputted from the button 8, the visual line direction detecting unit 7 detects the visual line direction of the user at that time. Specifically, the visual line direction detecting unit 7 obtains the visual line direction coordinates (Xd, Yd) in the display coordinate system, corresponding to an intersection point of the visual line direction at the time when the user is gazing and the display surface 4, and outputs the visual line direction coordinates (Xd, Yd) to the calibration unit 51.

The calibration unit 51 includes a calibration control unit 51a, a gazing object selecting unit 51b, a visual line direction coordinates storage unit 51c, a feature point position detecting unit 51d, a feature point position storage unit 51e, a calibration data computing unit 51f and an optimum direction determining unit 51g. The calibration unit 51 executes the calibration processing to compute the calibration data M when the calibration start trigger is inputted by pressing a predetermined button (not shown).

The optimum direction determining unit 51g receives the taken image taken by the imaging unit 2, and determines whether or not the taken image includes the optimum image-taking direction for the calibration processing. Specifically, the optimum direction determining unit 51g analyses the taken image of the surrounding to detect the image-taking direction in which plural natural feature points which are not similar and whose positions do not move disperse. When detecting the optimum image-taking direction from the taken image, the optimum direction determining unit 51g outputs an optimum direction detection signal indicating that the taken image includes the optimum image-taking direction to the calibration control unit 51a. Thus, the optimum direction determining unit 51g corresponds to an example of “a determining unit” of the present invention.

The calibration control unit 51a controls the calibration processing. Specifically, the calibration control unit 51a controls the gazing object selecting unit 51b, the calibration data computing unit 51f and the selector 54. When the calibration start trigger described above is inputted, the calibration control unit 51a starts the calibration processing. Specifically, when the calibration start trigger is inputted and the optimum direction detection signal is inputted from the optimum direction determining unit 51g, the calibration control unit 51a outputs a display updating signal for updating the gazing object image designating the natural feature point to be gazed by the user to the gazing object selecting unit 51b in response to the gazing completion signal from the button 8. Also, when the gazing completion signal is inputted a predetermined times from the button 8, the calibration control unit 51a outputs an operation trigger to the calibration data computing unit 51f and outputs a mode switching signal to the selector 54. As will be described later, the calibration data computingunit 51f computes the calibration dataMwhen the operation trigger is inputted. Also, when the mode switching signal is inputted, the selector 54 executes the mode switching that switches the data to be outputted to the display unit 1a between the data corresponding to the gazing object image (the gazing object image data) and the image data to be displayed as the additional information (the display data) such as CG.

When the display updating signal is inputted from the calibration control unit 51a, the gazing object selecting unit 51b selects the natural feature point to be gazed by the user, from the natural feature points included in the taken image (the image corresponding to the optimum image-taking direction), specifically selects one natural feature point that has not been gazed by the user yet in the present calibration processing, and generates the gazing object image data corresponding to the natural feature point. For example, the gazing object selecting unit 51b generates the image obtained by scaling down the taken image and emphasizing the natural feature point to be gazed by the user (e.g., the image in which the natural feature point to be gazed is shown by a specific color or the natural feature point is enclosed by a circle). Then, the gazing object selecting unit 51b outputs the gazing object image data thus generated to the selector 54. The gazing object selecting unit 51b corresponds to an example of “a designating unit” of the present invention.

The visual line direction coordinates storage unit 51c receives the visual line direction coordinates (Xd, Yd) from the visual line direction detecting unit 7, and stores the visual line direction coordinates (Xd, Yd). The visual line direction coordinates (Xd, Yd) correspond to the position coordinates of the natural feature point on the basis of the display coordinate system.

The feature point position detecting unit 51d receives the taken image taken by the imaging unit 2, and detects the three-dimensional position of the natural feature point to be gazed by the user. Specifically, the feature point position detecting unit 51d specifies the coordinates (Xc, Yc, Zc) indicating the position of the natural feature point selected by the gazing object selecting unit 51b based on the image data corresponding to the taken image, and outputs the specified position coordinates (Xc, Yc, Zc) to the feature point position storage unit 51e. The feature point position storage unit 51e stores the position coordinates (Xc, Yc, Zc) outputted from the feature point position detecting unit 51d. The position coordinates (Xc, Yc, Zc) correspond to the position coordinates of the natural feature point on the basis of the image-taking coordinate system. The feature point position detecting unit 51d corresponds to an example of “a position detecting unit” of the present invention.

When the operation trigger is inputted from the calibration control unit 51a, the calibration data computing unit 51f reads out the plural visual line direction coordinates (Xd, Yd) stored in the visual line direction coordinates storage unit 51c and position coordinates (Xc, Yc, Zc) of the plural natural feature points stored in the feature point position storage unit 51e. Then, the calibration data computing unit 51f computes the calibration data M, which is the matrix for the transformation from the image-taking coordinate system to the display coordinate system, based on the plural visual line direction coordinates (Xd, Yd) and the plural position coordinates (Xc, Yc, Zc) thus read out. When the calibration data computing unit 51f completes the computation of the calibration data M, it outputs an operation completion signal indicating the completion to the calibration control unit 51a. The calibration data computing unit 51f corresponds to an example of “a calibration unit” of the present invention.

Next, the transformation matrix computing unit 52 includes a marker detecting unit 52a and an Rmc computing unit 52b. The transformation matrix computing unit 52 computes a transformation matrix Rmc for the transformation from the coordinate system in the marker (hereinafter referred to as “a marker coordinate system”) to the image-taking coordinate system.

The marker detecting unit 52a detects the position and the size of the marker in the taken image taken by the imaging unit 2.

The Rmc computing unit 52b computes the transformation matrix Rmc for the transformation from the marker coordinate system to the image-taking coordinate system based on the position and the size of the marker detected by the marker detecting unit 52a. The Rmc computing unit 52b outputs the computed transformation matrix Rmc to the rendering unit 53. By updating the transformation matrix Rmc, the CG is displayed to follow the marker.

Next, the rendering unit 53 includes a CG data storage unit 53a, a marker to image-taking coordinates transforming unit 53b and an image-taking to display transforming unit 53c. The rendering unit 53 executes the rendering of the CG data to be displayed.

The CG data storage unit 53a stores CG data to be displayed. The CG data storage unit 53a stores the CG data prescribed by the marker coordinate system. The CG data stored in the CG data storage unit 53a is three-dimensional (3D) data. Hereinafter, the CG data stored in the CG data storage unit 53a will be referred to as “marker coordinate system data”.

The marker to image-taking coordinates transforming unit 53b receives the transformation matrix Rmc from the transformation matrix computing unit 52, and transforms the CG data stored in the CG data storage unit 53a from the marker coordinate system to the image-taking coordinate system based on the transformation matrix Rmc. Hereinafter, the CG data based on the coordinate system of the imaging unit 2 after the transformation by the marker to image-taking coordinate transforming unit 53b will be referred to as “image-taking coordinate system data”.

The image-taking to display transforming unit 53c receives the calibration data M from the calibration unit 51, and transforms the image-taking coordinate system data (3D) inputted from the marker to image-taking coordinate transforming unit 53b to the display data (coordinate transformation and projection transformation). The display data is two-dimensional (2D) data.

The image-taking to display transforming unit 53c outputs the display data to the selector 54.

The selector 54 selectively outputs the gazing object image data inputted from the calibration unit 51 and the display data inputted from the rendering unit 53 to the display unit 1a in accordance with the mode switching signal from the calibration unit 51. The selector 54 outputs the gazing object image data to the display unit 1a when the calibration processing is executed, and outputs the display data to the display unit 1a when the CG is displayed by the HMD 100. The display unit 1a displays the gazing object image based on the gazing object image data and displays the CG based on the display data.

[Processing Flow]

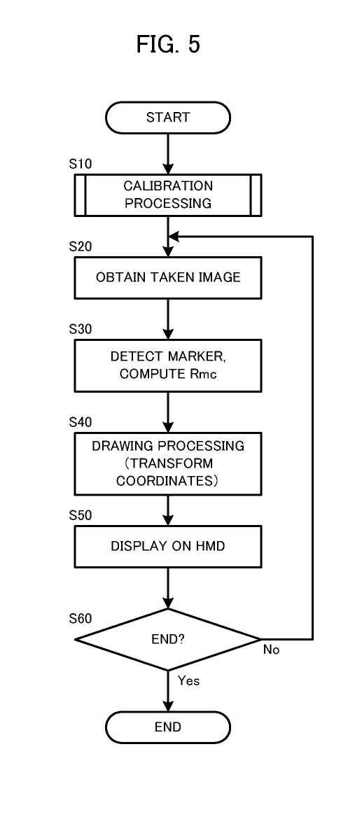

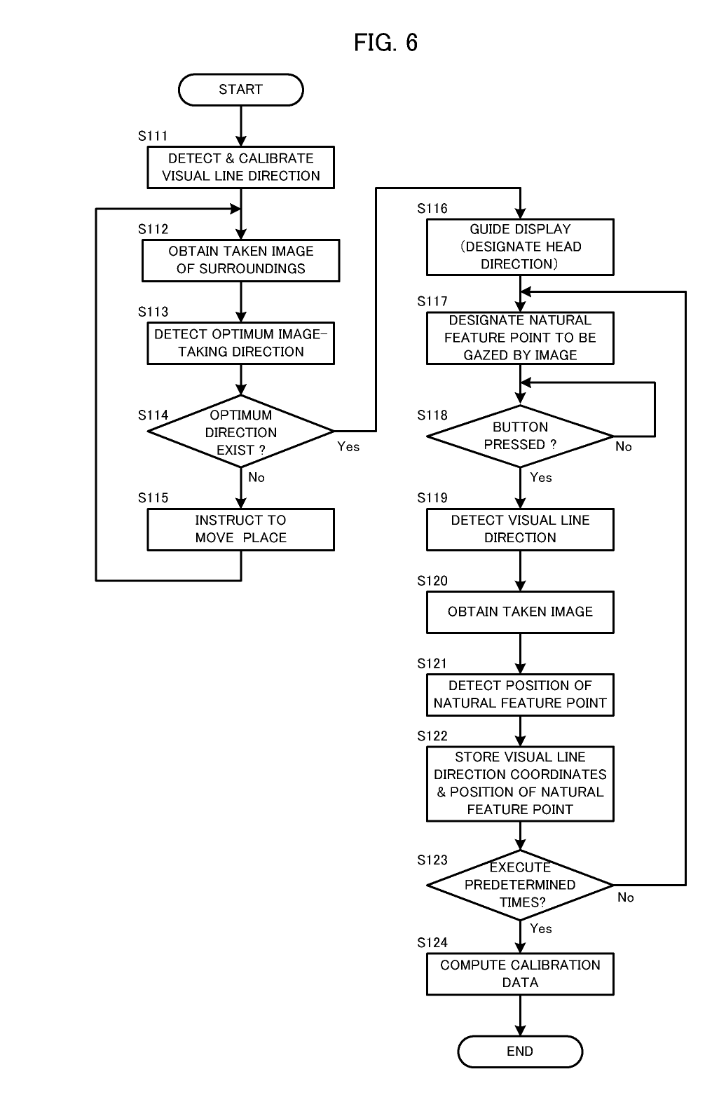

Next, a processing flow of this embodiment will be described with reference to FIGS. 5 and 6.

FIG. 5 is a flowchart showing an entire processing of the HMD 100.

First, in step S10, the calibration processing is executed. The detail of the calibration processing will be described later. Next, in step S20, the imaging unit 2 takes the image of the real environment. Namely, the HMD 100 obtains the taken image of the real environment by imaging the real environment by the imaging unit 2.

Next, in step S30, the transformation matrix computing unit 52 detects the marker subject to the addition of the additional information such as CG and computes the transformation matrix Rmc. Namely, the marker detecting unit 52a of the transformation matrix computing unit 52 detects the position, the posture (direction) and the size of the marker provided in the real environment based on the taken image of the real environment obtained by the imaging unit 2, and the Rmc computing unit 52b of the transformation matrix computing unit 52 computes the transformation matrix Rmc based on the position, the posture (direction) and size of the marker thus detected.

Next, in step S40, the drawing processing is executed which generates the display data of the CG to be displayed. In the drawing processing, first the marker coordinate system data stored in the CG data storage unit 53a is transformed to the image-taking coordinate system data based on the transformation matrix Rmc by the marker to image-taking coordinate transforming unit 53b. Next, the image-taking coordinate system data is transformed to the display data based on the calibration data M by the image-taking to display transformation unit 53c. The display data thus generated is inputted to the display unit 1a via the selector 54.

Next, in step S50, the HMD 100 displays the CG based on the display data. Then, in step S60, it is determined whether or not to end the display of the CG by the HMD 100. When it is determined to end the display (step S60: Yes), the display of the CG is ended. When it is not determined to end the display (step S60: No), the processing in step S20 is executed again.

FIG. 6 is a flowchart of step S10 described above.

First, in step S111, the user gazes the display of the HMD 100 plural times, and the calibration for the detection of the visual line direction is executed.

Next, in step S112, the imaging unit 2 obtains the taken image of the real environment. Specifically, the HMD 100 obtains the taken image of the real environment in a relatively broad area, which is obtained by imaging the real environment around the user by the imaging unit 2.

Next, in step S113, the optimum direction determining unit 51g of the calibration unit 51 detects the optimum image-taking direction included in the taken image. Specifically, the optimum direction determining unit 51g analyzes the taken image to detect the image-taking direction in which plural natural feature points which are not similar and whose positions do not move disperse. When the taken image includes the optimum image-taking direction (step S11: Yes), the processing goes to step S116. In contrast, when the taken image does not include the optimum image-taking direction (step S114: No), the processing goes to step S115. In this case, the user is instructed to move the place (step S115), and the processing in step S112 is executed again. Namely, the user changes the place to take the image of surrounding again.

In step S116, the direction of the user's head is guided to the detected optimum image-taking direction. For example, the direction of the user's head is guided by displaying an image of an arrow indicating the optimum image-taking direction.

Next, in step s117, the calibration unit 51 designates the natural feature point to be gazed by the user. Specifically, the gazing object image in accordance with the natural feature point selected by the gazing object selecting unit 51b of the calibration unit 51 is displayed. Then, in step S118, it is determined whether or not the button 8 is pressed. Namely, it is determined whether or not the user gazes the designated natural feature point.

When the button 8 is pressed (step S118: Yes), the processing goes to step S119. On the other hand, when the button 8 is not pressed (step S118: No), the determination in step S118 is executed again. Namely, the determination in step S118 is repeated until the button 8 is pressed.

In step S119, the visual line direction detecting unit 7 detects the visual line direction of the user. Specifically, the visual line direction detecting unit 7 obtains the visual line direction coordinates (Xd, Yd), which are the coordinates in the display coordinate system, corresponding to the intersection point of the visual line direction of the user and the display surface 4.

Next, in step S120, the imaging unit 2 obtains the taken image of the real environment (i.e., the image corresponding to the optimum image-taking direction). Then, in step S121, the feature point position detecting unit 51d of the calibration unit 51 detects, from the taken image, the three-dimensional position of the natural feature point gazed by the user. Specifically, the feature point position detecting unit 51d obtains the position coordinates (Xc, Yc, Zc) of the natural feature point selected by the gazing object selecting unit 51b, based on the image data corresponding to the taken image.

Next, in step S122, the visual line direction coordinates (Xd, Yd) obtained in step S119 and the position coordinates (Xc, Yc, Zc) of the natural feature point obtained in step S121 are stored. Specifically, the visual line direction coordinates (Xd, Yd) are stored in the visual line direction coordinates storage unit 51c, and the position coordinates (Xc, Yc, Zc) of the natural feature point are stored in the feature point position storage unit 51e.

Next, in step S123, it is determined whether or not the processing in steps S117 to S122 is executed predetermined times. The predetermined times used in the above determination is determined in accordance with the accuracy of the calibration processing, for example.

When the processing in steps S117 to S112 is executed predetermined times (step S123: Yes), the calibration data computing unit 51f of the calibration unit 51 computes the calibration data M (step S124). Specifically, the calibration data computing unit 51f computes the calibration data M based on the plural visual line direction coordinates (Xd, Yd) stored in the visual line direction coordinates storage unit 51c and the position coordinates (Xc, Yc, Zc) of the plural natural feature points stored in the feature point position storage unit 51e. On the other hand, when the processing in steps S117 to S122 is not executed the predetermined times (step S123: No), the processing in the step S117 is executed again.

Since the visual line direction of a human being tends to be unstable even at the time of gazing, the error of the calibration data M may become large by the calibration processing using only the visual line direction at the time when the button 8 is pressed. Accordingly, it is preferable to determine the visual line direction by obtaining the visual line direction data of one second before and after the timing when the button 8 is pressed and applying averaging processing and/or histogram processing to the data thus obtained. Thus, the error of the calibration data M may be reduced.

In comparison with Non-Patent Reference 1, since this embodiment uses, not an artificial feature point such as a marker, but the natural feature point, the calibration can be appropriately executed in an environment including no marker. Also, according to this embodiment, by utilizing the taken image by the imaging unit 2 and the display function of the display unit 1a, the natural feature point at the time of the calibration can be designated in a manner easy to find.

In addition, unlike the technique of Patent References 1 and 3 mentioned above, this embodiment can appropriately cope with the setting and/or the position change of the imaging unit 2 and the HMD 100 as well as the position change of the eyes.

### Modified Examples

The modified examples preferable to the above embodiment will be described below. The following modified examples may be applied to the above embodiment in a manner appropriately combined with each other.

### 1st Modified Example

In the embodiment described above, the user notifies his or her gazing to the HMD 100 by pressing the button 8 when he or she gazes. However, the work of pressing the button 8 may reduce concentration of the user and disturb the visual line direction, or may influence the position of the head of the user. Therefore, in another example, the completion of gazing may be determined when the user performs the gazing for a predetermined time period, instead of notifying the completion of the gazing by pressing the button 8. Namely, at the time when the user performs the gazing for the predetermined time period, the visual line direction may be detected. By this, the disturbance of the visual line direction and/or the movement of the head may be suppressed, thereby reducing the error factor at the time of the calibration and improving the accuracy of the calibration.

In still another example, the completion of the gazing may be determined when the user blinks during the gazing. Namely, at the timing of the user's blink, the visual line direction may be detected. By this, the disturbance of the visual line direction and/or the movement of the head may be suppressed, thereby reducing the error factor at the time of the calibration and improving the accuracy of the calibration.

The completion of the gazing may be determined when the user performs the gazing for a predetermined time period or the user blinks during the gazing is satisfied.

### 2nd Modified Example

While the calibration for the detection of the visual line direction is performed manually in the above embodiment, the calibration may be performed automatically. In that case, it is not necessary to execute the processing in step S111 in the calibration processing shown in FIG. 6. In addition, in case of using the detection method which does not require the calibration for the detection of the visual line direction, it is not necessary to perform the processing in step S111.

### 3rd Modified Example

While the above embodiment shows the example of executing the calibration based on the visual line direction, the present invention is not limited to this. Specifically, the present invention is not limited to the method of obtaining the visual line direction coordinates corresponding to the intersection point of the visual line direction when the user gazes the natural feature point and the display surface 4, as the position of the natural feature point on the basis of the display coordinate system. In another example, an image of a cross may be displayed and the user may make the position of the displayed cross coincide with the position of the natural feature point (the designated natural feature point). The position of the cross at that time may be determined as the position of the natural feature point on the basis of the display coordinate system, instead of the visual line direction coordinates. Namely, such a calibration method that the user repeatedly performs the operation of making the position of the displayed cross coincide with the position of the natural feature point and notifying it by the button 8 (e.g., the method described in Non-Patent Reference 1) may be applied to the present invention.

### 4th Modified Example

In the above embodiment, the natural feature point is presented to the user by displaying the image (the gazing object image). In another example, the actual object position (i.e., natural feature point) may be presented by a laser, instead of displaying the gazing object image.

In addition, the marker detection unit 52a may use an image marker and may use a natural feature point, instead of the marker detection described above.

### 5th Modified Example

The application of the present invention is not limited to the HMD 100. The present invention may be applied to various see-through displays realizing an optically transmissive type AR. For example, the present invention is applicable to a head up display (HUD) and a see-through display.

### INDUSTRIAL APPLICABILITY

This invention can be used for an optically transmissive type display device, such as a head mount display.

### DESCRIPTION OF REFERENCE NUMBERS

1 Optically Transmissive Display Unit
1a Display Unit
2 Imaging Unit
3 Mounting Parts
4 Display Surface
5 Control Unit
6 Near Infrared Light Source
7 Visual Line Direction Detecting Unit
51 Calibration Unit
52 Transformation Matrix Computing Unit
53 Rendering Unit
100 Head Mount Display (HMD)

1. A display device of optically transmissive type which displays additional information to a real environment visually recognized by a user, comprising:
a position detecting unit which detects a specific position in the real environment;
a calibration unit which obtains a correspondence between the specific position in the real environment and a specific position of the display device to compute calibration data for transforming from a first coordinate system of the position detecting unit at the specific position in the real environment to a second coordinate system of the display device; and
a determining unit which determines a natural feature point suitable for computing the calibration data in the natural feature points existing in the real environment, based on a taken image taken by imaging the real environment by an imaging device,
wherein the position detecting unit specifies the specific position in the real environment in the calibration unit by detecting the position of the natural feature point determined by the determining unit.

2. The display device according to claim 1, further comprising a presenting unit which presents the natural feature point determined by the determining unit to the user.

3. The display device according to claim 2, wherein the presenting unit displays an image in accordance with the taken image of the real environment including the natural feature point.

4. The display device according to claim 1,
wherein the determining unit determines an optimum image-taking direction including the natural feature point for an image-taking direction of the imaging device based on the taken image,
wherein the position detecting unit detects the position of the natural feature point included in the optimum image-taking direction, and
wherein the first coordinate system is a coordinate system of the imaging device.

5. The display device according to claim 4, wherein the determining unit determines, as the optimum image-taking direction, the image-taking direction in which plural natural feature points which are not similar and whose position does not move disperse.

6. The display device according to claim 1, further comprising a visual line direction detecting unit which detects a visual line direction of the user when the user directs the visual line to the natural feature point,
wherein the calibration unit computes the calibration data based on the position detected by the position detecting unit and the visual line direction detected by the visual line detecting unit.

7. The display device according to claim 6, wherein the visual line direction detecting unit detects the visual line direction when the user operates an input unit for inputting that the user is gazing.

8. The display device according to claim 6, wherein the visual line direction detecting unit detects the visual line direction when the user performs the gazing operation for a predetermined time period.

9. The display device according to claim 6, wherein the visual line direction detecting unit detects the visual line direction when the user blinks.

10. The display device according to claim 6,
wherein the visual line direction detecting unit obtains the coordinates in the second coordinate system corresponding to an intersection point of the visual line direction and a display surface by the display device, and
wherein the calibration unit computes the calibration data based on the coordinates obtained by the visual line direction detecting unit and the position detected by the position detecting unit.

11. A head mount display of optically transmissive type which displays additional information to a real environment visually recognized by a user, comprising:
a position detecting unit which detects a specific position in the real environment;
a calibration unit which obtains a correspondence between the specific position in the real environment and a specific position of the display device to compute calibration data for transforming from a first coordinate system of the position detecting unit at the specific position in the real environment to a second coordinate system of the display device; and
a determining unit which determines a natural feature point suitable for computing the calibration data in the natural feature points existing in the real environment, based on a taken image taken by imaging the real environment by an imaging device,
wherein the position detecting unit specifies the specific position in the real environment in the calibration unit by detecting the position of the natural feature point determined by the determining unit.

12. A calibration method executed by a display device of optically transmissive type which displays additional information to a real environment visually recognized by a user, comprising:
a position detecting process which detects a specific position in the real environment;
a calibration process which obtains a correspondence between the specific position in the real environment and a specific position of the display device to compute calibration data for transforming from a first coordinate system prescribed by the position detecting process at the specific position in the real environment to a second coordinate system of the display device; and
a determining process which determines a natural feature point suitable for computing the calibration data in the natural feature points existing in the real environment, based on a taken image taken by imaging the real environment by an imaging device,
wherein the position detecting process specifies the specific position in the real environment in the calibration process by detecting the position of the natural feature point determined by the determining process.

13. A calibration program stored in a non-transitory computer-readable medium and executed by a display device of optically transmissive type which includes a computer and which displays additional information to a real environment visually recognized by a user, making the computer function as:
a position detecting unit which detects a specific position in the real environment;
a calibration unit which obtains a correspondence between the specific position in the real environment and a specific position of the display device to compute calibration data for transforming from a first coordinate system of the position detecting unit at the specific position in the real environment to a second coordinate system of the display device; and
a determining unit which determines a natural feature point suitable for computing the calibration data in the natural feature points existing in the real environment, based on a taken image taken by imaging the real environment by an imaging device,
wherein the position detecting unit specifies the specific position in the real environment in the calibration unit by detecting the position of the natural feature point determined by the determining unit.

14. (canceled)

15. The display device according to claim 2,
wherein the determining unit determines an optimum image-taking direction including the natural feature point for an image-taking direction of the imaging device based on the taken image,
wherein the position detecting unit detects the position of the natural feature point included in the optimum image-taking direction, and
wherein the first coordinate system is a coordinate system of the imaging device.

16. The display device according to claim 3,
wherein the determining unit determines an optimum image-taking direction including the natural feature point for an image-taking direction of the imaging device based on the taken image,
wherein the position detecting unit detects the position of the natural feature point included in the optimum image-taking direction, and
wherein the first coordinate system is a coordinate system of the imaging device.

17. The display device according to claim 2, further comprising a visual line direction detecting unit which detects a visual line direction of the user when the user directs the visual line to the natural feature point,
wherein the calibration unit computes the calibration data based on the position detected by the position detecting unit and the visual line direction detected by the visual line detecting unit.

18. The display device according to claim 3, further comprising a visual line direction detecting unit which detects a visual line direction of the user when the user directs the visual line to the natural feature point,
wherein the calibration unit computes the calibration data based on the position detected by the position detecting unit and the visual line direction detected by the visual line detecting unit.

19. The display device according to claim 4, further comprising a visual line direction detecting unit which detects a visual line direction of the user when the user directs the visual line to the natural feature point,
wherein the calibration unit computes the calibration data based on the position detected by the position detecting unit and the visual line direction detected by the visual line detecting unit.

20. The display device according to claim 5, further comprising a visual line direction detecting unit which detects a visual line direction of the user when the user directs the visual line to the natural feature point,
wherein the calibration unit computes the calibration data based on the position detected by the position detecting unit and the visual line direction detected by the visual line detecting unit.

21. The display device according to claim 7,
wherein the visual line direction detecting unit obtains the coordinates in the second coordinate system corresponding to an intersection point of the visual line direction and a display surface by the display device, and
wherein the calibration unit computes the calibration data based on the coordinates obtained by the visual line direction detecting unit and the position detected by the position detecting unit.
